(19) United States
(12) Patent Application Publication
(10) Pub. No.: US 2005/0208982 A1
(43) Pub. Date: Sep. 22, 2005

(54) Duplex wireless storing device

(75) Inventor: Chia-Chun Tung, Taipei City (TW)

Correspondence Address: BRUCE H. TROXELL, SUITE 1404, 5205 LEESBURG PIKE, FALLS CHURCH, VA, 22041, US

(73) Assignee: Blue Expert Technology Corporation

(21) Appl. No.: 11/052,948

(22) Filed: Feb. 9, 2005

(30) Foreign Application Priority Data
Mar. 9, 2004 (TW) 93213988

(51) Int. Cl. H04B 7/00; H04M 1/00; H04B 1/38

(52) U.S. Cl. 455/572; 455/41.2; 455/573

(57) ABSTRACT

Disclosed is a duplex wireless storing device, comprising: a power module, for providing power to the duplex wireless storing device; a Bluetooth module, connected to an antenna for receiving/transmitting signals; a micro-processor, for encoding, decoding and modulating the signals received/transmitted by/from the Bluetooth module; a memory unit, coupled to the microprocessor for storing data processed by the microprocessor; and a connection port, coupled to a transmission interface of a computer for transmitting/receiving data to/from the computer.

### 1. FIELD OF THE INVENTION

The present invention relates to a duplex wireless storing device, and more particularly, to a Bluetooth-enabled wireless storing device, capable of performing a short-range data transmission, having a flash disk with Bluetooth module built therein for transferring data between different electronic devices.

### 2. BACKGROUND OF THE INVENTION

Along with the advance of technology, wireless communication devices have been widely used in our daily life. Bluetooth wireless technology is a promising wireless communication technology that has been gradually applied to the wireless communication products. A Bluetooth wireless device is equipped with stable transmitting and receiving capabilities of wireless signals, especially in the case where a short distance wireless communication is involved. With the advance and maturity of the Bluetooth wireless technology and the strong needs of Bluetooth chips, more and more companies producing electronic products, such as notebook computer, PDA and mobile phone, etc., has already involved themselves into the production of Bluetooth-enabled mobile phone, and thus the cost of Bluetooth chip has become lower and lower.

Generally, the current miniature electronic devices, such as mobile phones, PDAs and digital cameras, have the problem of having no sufficient memory space. When application programs or data are downloaded from wireless network, the shortage of memory space in these miniature electronic devices is often encountered. Furthermore, some miniature electronic devices are not equipped with slots for memory expandability, such as slots for flash memory cards. Accordingly, the miniature electronic devices may not reach their maximum performances and satisfy users' demands.

For the past years, transmission interfaces of computers, such as the USB interface and IEEE 1394 interface, have gained significant improvements in their transmission speeds and a number of external storing devices emerge correspondingly in the market, e.g. external hard disks, external DVD drives, external flash disks and external floopies. Of these external storing devices, the flash disk could be the most popular storing device. Generally, the capacity of current flash disk is about tens Mbyte to one Gbyte, which may be enough and convenient for transferring of data of small volume, for example, from a computer A to a computer B. In doing this, the user first inserts the flash disk to a corresponding transmission interface of the computer A and then copies the desired data in the computer A to the flash disk. After the copying operation is finished, the flash disk is removed from the computer A and inserted into the computer B at a corresponding transmission interface. Then, the data in the flash disk is transferred or copied into the computer B. Owing to the better convenience of carrying and the relatively larger capacity, the external flash disk is tend to replace the external floppy.

Although the external flash disk has the above-mentioned advantages, it is still preferred to combine the Bluetooth wireless transmission technology with a storing device, e.g. a flash card, for facilitating data transferring between different electronic products wireless and conveniently, such as between a mobile phone, a PDA and a computer.

### SUMMARY OF THE INVENTION

In view of the above description, it is an primary object of the invention to provide a duplex wireless storing device in which wireless Bluetooth technology is used and a Bluetooth module is built therein so that the duplex wireless storing device may be used as an intermediate in data transmission from an electronic device to a different electronic device, such as from a mobile phone to a computer and a personal digital assistant (PDA) to a computer. By means of matching the duplex wireless storing device, which is further connected to a computer or a notebook, with a Bluetooth-enable mobile phone, PDA or the like for achieving operations of data transferring and editing, the problem of insufficient memory space for miniature electronic devices is solved and a multi-functional storing device is thus accomplished.

To achieve the above object, a duplex wireless storing device according to the present invention comprises:
a power module, for providing power the duplex wireless storing device;
a Bluetooth module, connected to an antenna for receiving/transmitting signals;
a microprocessor, for encoding, decoding and modulating the signals received/transmitted by/from the Bluetooth module;
a memory unit, coupled to the microprocessor for storing data processed by the microprocessor; and
a connection port, connected to a transmission interface of a computer for transmitting/receiving data to/from the computer.

### BRIEF DESCRIPTION OF THE DRAWINGS

The invention will become more fully understood from the detailed description given hereinbelow illustration only, and thus are not limitative of the present invention, and wherein:

FIG. 1 is a functional block diagram of a duplex wireless storing device according to the present invention; and

FIG. 2 is diagram showing an embodiment of the duplex wireless storing device according to the present invention.

### DETAILED DESCRIPTION OF THE INVENTION

The structure and principle of the present invention will be described in detail through the preferred embodiments as follows with reference to the accompanying drawings.

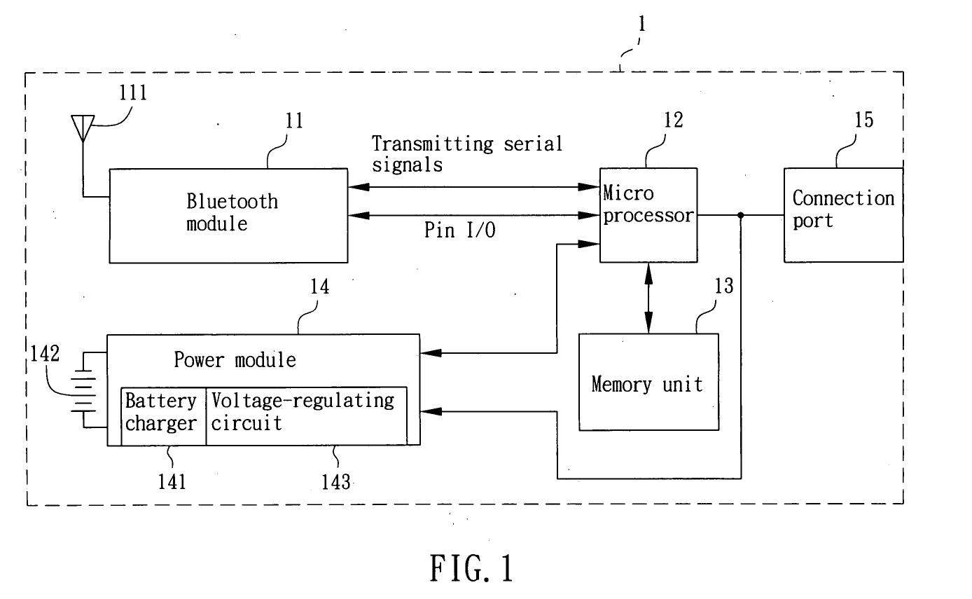

Referring to FIG. 1, a functional block diagram of a duplex wireless storing device according to the present invention is illustrated. The duplex wireless storing device 1 comprises a power module 14, a Bluetooth module 11, a microprocessor 12, a memory unit 13 and a connection port 15. In a preferred embodiment, the duplex wireless storing device is a flash disk.

The power module 14 provides a specified power supply to the duplex wireless storing device 1 which comprises a battery charger 141 for charging a rechargeable battery 142. The battery charger 141 may charge the battery 142 through a transformer, a car charger or a current supplied by a USB port of a computer. The rechargeable battery 142 may be a Li-ion battery, a Ni-MH battery or a Ni—Cd battery. Alternatively, a non-rechargeable battery may also be used, such as a Zn—C battery or an alkaline battery The power \module 14 further comprises a voltage regulating circuit 143 for stabilizing the voltage outputted therefrom.

The Bluetooth module 11 is connected with an antenna 111 for receiving or transmitting signals through the antenna 111.

The microprocessor 12 encodes, decodes and modulates data in the signals transmitted from/to the Bluetooth module 11.

The memory unit 13 is coupled to the microprocessor 12 for storing data processed by the microprocessor 12. The memory unit 13 may be an internal memory or an external flash memory such as compact flash cards (CF), smart media cards (SM), multi-media cards (MMC), secure digital cards (SD), memory sticks (MS) and Extreme Digital (xD).

The connection port 14 is connected to the computer for transmitting/receiving data/from the computer. The connection port 14 may be an IEEE 1394 interface or an USB interface.

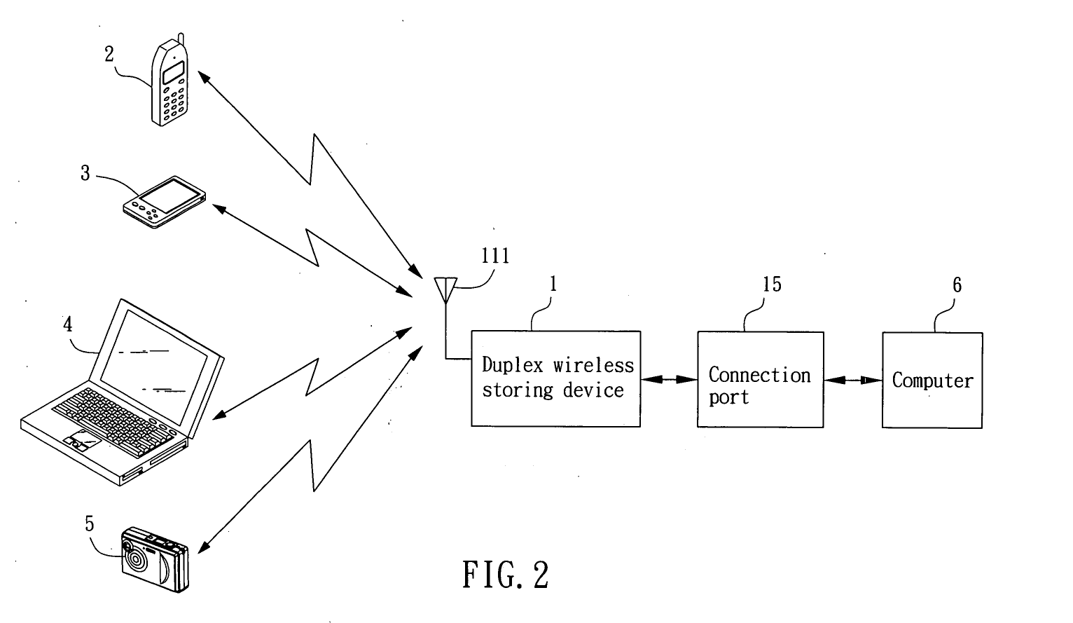

Referring to FIG. 2, an embodiment o of the duplex wireless storing device according to the present invention is illustrated. In this embodiment, the duplex wireless storing device may receive or transmit data from or to a Bluetooth-enabled mobile phone 2, a Bluetooth-enabled PDA 3, a Bluetooth-enabled notebook computer 4 and a Bluetooth-enabled camera 5 or the like wireless by matching the Bluetooth modules built therein. In actual data transmission, the desired data stored in the Bluetooth-enabled mobile phone 2, for example, may be transmitted into the duplex wireless storing device 1 wirelessly, or the desired data stored in the duplex wireless storing device 1 may be transmitted to the Bluetooth-enabled mobile phone 2 through the antenna 111. Owing to the wireless capability of the Bluetooth modules built therein, there is no cable required to be involved in the data transmission and there is no limitation restricting data to be transmitted only between devices with common transmission port. Therefore, any electronic device having the Bluetooth module built therein may be used with the wireless duplexer. That is, data in any Bluetooth-enabled electronic device may be transmitted to other electronic devices through the duplex wireless storing device as depicted in FIG. 1.

If a user of the duplex wireless storing device 1 desires to copy or transfer the data in the Bluetooth-enabled electronic device to a computer 5, he may connect the duplex wireless storing device to the computer 5 through the connection port 15. The connection port 15 may be an USB port or a IEEE 1394 port. Therefore, the mobile phones, PDAs and the like may each be supported with a larger memory space by means of the inventive duplex wireless storing device and a multi-functional storing device is thus achieved.

While the preferred embodiments of the present invention have been set forth for the purpose of disclosure, modifications of the disclosed embodiments of the present invention as well as other embodiments thereof may occur to those skilled in the art. Accordingly, the appended claims are intended to cover all embodiments which do not depart from the spirit and scope of the present invention.

1. A duplex wireless storing device, comprising:
a power module, for providing a power supply to the duplex wireless storing device;
a Bluetooth module, connected to an antenna for receiving/transmitting signals;
a microprocessor, for encoding, decoding and modulating the signals received/transmitted by/from the Bluetooth module;
a memory unit, coupled to the microprocessor for storing data processed by the microprocessor; and
a connection port, connected to a transmission interface of a computer for transmitting/receiving data to/from the computer.

2. The device as recited in claim 1, wherein the power module further comprises a battery charger for charging corresponding rechargeable batteries used as the power supply.

3. The device as recited in claim 2, wherein the rechargeable battery is a battery selected from the group consisting of Li-ion battery, Ni-MH battery and Ni—Cd battery.

4. The device as recited in claim 2, wherein the current provided to the battery charger is transmitted through a device selected from the group consisting of a transformer, a car charger, an USB port of a computer.

5. The device as recited in claim 1, wherein the power supply of the power module is a primary battery.

6. The device as recited in claim 1, wherein the power module further comprises a voltage regulating circuit 143 for stabilizing the voltage outputted therefrom.

7. The device as recited in claim 1, wherein the memory unit is substantially a built-in memory.

8. The device as recited in claim 1, wherein the memory unit is substantially an external flash memory.

9. The device as recited in claim 7, wherein the flash memory is selected from the group consisting of compact flash cards (CF), smart media cards (SM), multi-media cards (MMC), secure digital cards (SD), memory sticks (MS) and Extreme Digital (xD).

10. The device as recited in claim 1, wherein the connection port is substantially an IEEE 1394 interface.

11. The device as recited in claim 1, wherein the connection port is substantially an USB interface.
